(19) United States
(12) Patent Application Publication
(10) Pub. No.: US 2024/0105182 A1
(43) Pub. Date: Mar. 28, 2024

(54) SPEAKER DIARIZATION METHOD, SPEAKER DIARIZATION DEVICE, AND SPEAKER DIARIZATION PROGRAM

(71) Applicant: NIPPON TELEGRAPH AND TELEPHONE CORPORATION, Tokyo (JP)

(72) Inventors: Atsushi ANDO, Tokyo (JP); Yumiko MURATA, Tokyo (JP); Takeshi MORI, Tokyo (JP)

(73) Assignee: NIPPON TELEGRAPH AND TELEPHONE CORPORATION, Tokyo (JP)

(21) Appl. No.: 18/266,513

(22) PCT Filed: Dec. 14, 2020
(86) PCT No.: PCT/JP2020/046585

§ 371 Date: Jun. 9, 2023

(51) Int. Cl. G10L 17/04; G10L 15/04; G10L 17/02; G10L 17/18

(52) U.S. Cl. CPC G10L 17/04; G10L 15/04; G10L 17/02; G10L 17/18

(57) ABSTRACT

An array generating unit (15b) divides a sequence of acoustic features for each frame of an acoustic signal into segments of a predetermined length and generates an array in which a plurality of divided segments in a row direction are arranged in a column direction. A learning unit (15d) generates by learning, using the array, a speaker diarization model (14a) for estimating a speaker label of a speaker vector of each frame.

### TECHNICAL FIELD

The present invention relates to a speaker diarization method, a speaker diarization apparatus, and a speaker diarization program.

### BACKGROUND ART

In recent years, a speaker diarization technique which accepts an acoustic signal as input and which identifies utterance sections of all speakers included in the acoustic signal has been anticipated. The speaker diarization technique can be applied in various ways such as automatic transcription which records who and when an utterance had been made in a conference and automatic segmentation of utterances between an operator and a customer from a call at a contact center. Conventionally, a technique called EEND (End-to-End Neural Diarization) based on deep learning has been disclosed as a speaker diarization technique (refer to NPL 1). In EEND, an acoustic signal is divided into frames and a speaker label representing whether or not a specific speaker exists in a frame is estimated for each frame from an acoustic feature extracted from the frame. When the maximum number of speakers in the acoustic signal is denoted by S, the speaker label for each frame is an S-dimensional vector which takes a value of 1 when a certain speaker speaks in the frame but takes a value of 0 when the speaker does not speak in the frame. In other words, in EEND, speaker diarization is realized by performing multi-label binary classification as many times as the number of speakers.

An EEND model used for estimating a speaker label sequence for each frame in EEND is a deep learning-based model which is made up of layers capable of backpropagation and which enables the speaker label sequence for each frame to be estimated from an acoustic feature sequence in a comprehensive manner. The EEND model includes an RNN (Recurrent Neural Network) layer for performing time-series modeling. Accordingly, in EEND, the speaker label for each frame can be estimated by using an acoustic feature amount of not only the frame but also surrounding frames thereof. A bidirectional LSTM (Long Short-Term Memory)-RNN or a Transformer Encoder is used for the RNN layer.
NPL2 describes an RNN transducer. In addition, NPL 3 describes an acoustic feature amount.

### CITATION LIST

### Non Patent Literature

[NPL 1] Yusuke Fujita, Naoyuki Kanda, Shota Horiguchi, Yawen Xue, Kenji Nagamatsu, Shinji Watanabe, “END-TO-END NEURAL SPEAKER DIARIZATION WITH SELF-ATTENTION”, Proc. ASRU, 2019, pp. 296-303.
[NPL 2] Yi Luo, Zhuo Chen, Takuya Yoshioka, “DUAL-PATH RNN: EFFICIENT LONG SEQUENCE MODELING FOR TIME-DOMAIN SINGLE-CHANNEL SPEECH SEPARATION”, ICASSP, 2020.
[NPL 3] Kiyohiro Shikano, Katsunori Ito, Tatsuya Kawahara, Kazuya Takeda, Mikio Yamamoto, “Voice Recognition System”, Ohmsha, 2001, pp. 13-14.

### SUMMARY OF INVENTION

### Technical Problem

However, in prior art, it has been difficult to perform speaker diarization with respect to a long acoustic signal with high accuracy. In other words, since it is difficult for the RNN layer to handle a very long acoustic feature sequence in a conventional EEND model, when a very long acoustic signal is input, there is a possibility that errors in speaker diarization may increase.

For example, when using a BLSTM-RNN as the RNN, the BLSTM-RNN uses internal states of an input frame and an adjacent frame thereof to estimate a speaker label of the input frame. Therefore, the farther a frame is from the input frame, the more difficult it is to use an acoustic feature of the frame to estimate a speaker label.

In addition, when a transformer encoder is used as the RNN, an EEND model is trained so as to estimate which frame contains information useful for estimating the speaker label of the frame. Therefore, as an acoustic feature sequence becomes longer, choices of frame estimation increases to make it difficult to estimate a speaker label.

The present invention has been devised in view of the foregoing circumstances and an object thereof is to perform speaker diarization with respect to a long acoustic signal with high accuracy.

### Solution to Problem

In order to solve the problem and achieve the object described above, a speaker diarization method according to the present invention includes the steps of: dividing a sequence of acoustic features for each frame of an acoustic signal into segments of a predetermined length and generating an array in which a plurality of divided segments in a row direction are arranged in a column direction; and generating by learning, using the array, a model for estimating a speaker label of a speaker vector of each frame.

### Advantageous Effects of Invention

According to the present invention, speaker diarization with respect to a long acoustic signal can be performed with high accuracy.

### BRIEF DESCRIPTION OF DRAWINGS

FIG. 1 is a diagram for describing an overview of a speaker diarization apparatus.

FIG. 2 is a schematic diagram illustrating a schematic configuration of the speaker diarization apparatus.

FIG. 3 is a diagram for describing processing of the speaker diarization apparatus.

FIG. 4 is a diagram for describing processing of the speaker diarization apparatus.

FIG. 5 is a flowchart showing speaker diarization processing procedures.

FIG. 6 is a flowchart showing speaker diarization processing procedures.

FIG. 7 is a diagram illustrating a computer that executes a speaker diarization program.

### DESCRIPTION OF EMBODIMENTS

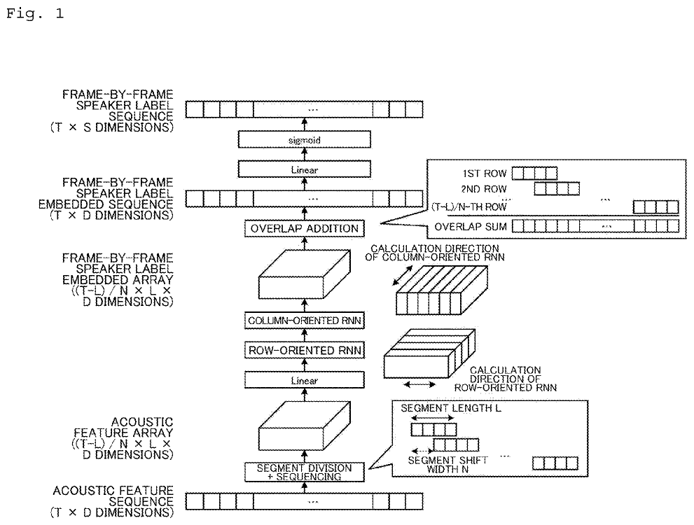

Hereinafter, an embodiment of the present invention will be described in detail with reference to the drawings. The present invention is not limited by the present embodiment. Furthermore, in the description of the drawings, same parts are denoted by same reference signs. [Overview of speaker diarization apparatus] FIG. 1 is a diagram for describing an overview of a speaker diarization apparatus. As shown in FIG. 1, a speaker diarization apparatus according to the present embodiment divides an input two-dimensional acoustic feature sequence into segments and converts the segments into a three-dimensional acoustic feature array. In addition, the acoustic feature array is input to a speaker diarization model including two series models of a column-direction RNN and a row-direction RNN.

Specifically, the speaker diarization apparatus divides a two-dimensional acoustic feature sequence of T-number of frames×D-number of dimensions into segments of L-number of frames by a shift width of N-number of frames. In addition, with each segment as each row, heads of the respective rows are connected so as to be aligned in the column direction to generate a three-dimensional acoustic feature array of (T-L)/N-number of rows×L-number of columns×D-number of dimensions.

A row-oriented RNN layer for performing RNN processing on each row is applied to the array generated in this manner and a hidden layer output is obtained using the acoustic feature sequence in each segment. Subsequently, a column-oriented RNN layer for performing RNN processing on each column is applied to the array to obtain a hidden layer output sequence that straddles a plurality of segments and an embedded sequence to be used to estimate a speaker label for each frame is obtained. In addition, each row of the embedded sequence for each frame is overlapped and added to obtain a speaker label embedded sequence for each frame of the T-number of frames. Thereafter, the speaker diarization apparatus obtains a speaker label sequence for each frame using a Linear layer and a sigmoid layer.

In this manner, by applying the row-oriented RNN layer, the speaker diarization apparatus can perform speaker diarization using local contextual information. In this case, a same speaker label tends to be output in adjacent frames. Furthermore, by applying the column-oriented RNN layer, the speaker diarization apparatus can perform speaker diarization using global contextual information. Accordingly, utterances by a same speaker separated in time can be adopted as objects of speaker diarization.

[Configuration of Speaker Diarization Apparatus]

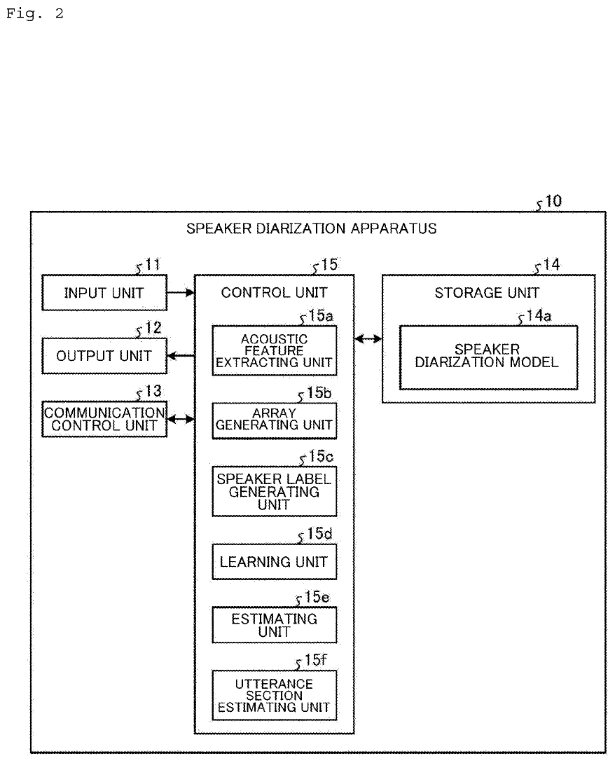

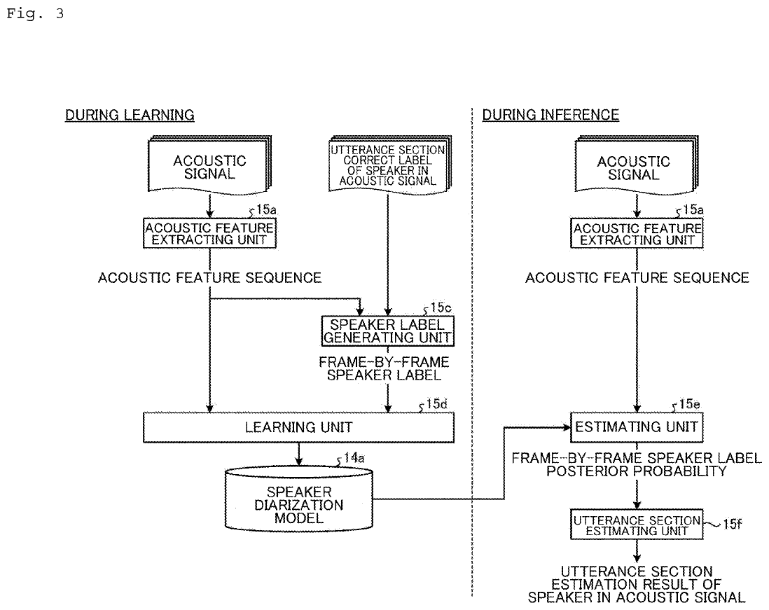

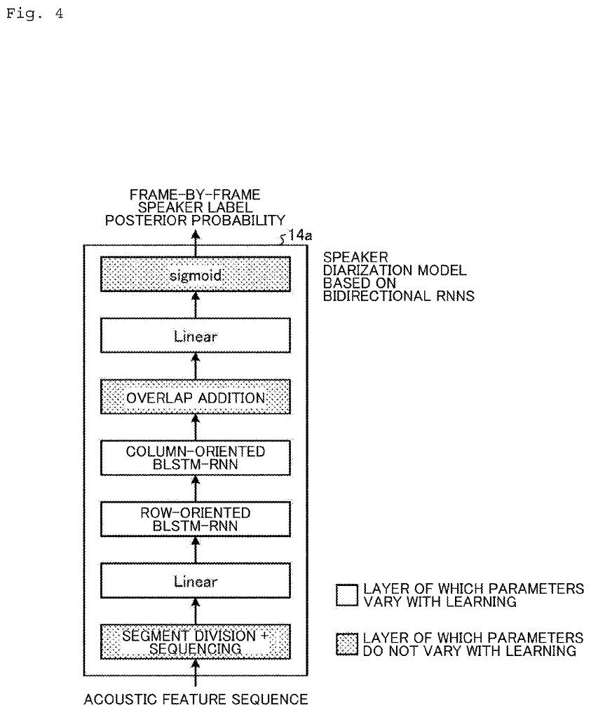

FIG. 2 is a schematic diagram illustrating a schematic configuration of the speaker diarization apparatus. In addition, FIG. 3 and FIG. 4 are diagrams for illustrating processing of the speaker diarization apparatus. First, as illustrated in FIG. 2, a speaker diarization apparatus 10 according to the present embodiment is implemented by a general-purpose computer such as a personal computer and includes an input unit 11, an output unit 12, a communication control unit 13, a storage unit 14, and a control unit 15.

The input unit 11 is implemented using an input device such as a keyboard or a mouse and receives various types of instruction information such as a processing start instruction for the control unit 15 in accordance with input operations performed by an operator. The output unit 12 is implemented by a display apparatus such as a liquid crystal display, a printing apparatus such as a printer, an information communication apparatus, or the like. The communication control unit 13 is implemented by an NIC (Network Interface Card) or the like and controls communication between an external apparatus such as a server or an apparatus that acquires an acoustic signal and the control unit 15 via a network.

The storage unit 14 is implemented by a semiconductor memory device such as a RAM (Random Access Memory) or a flash memory, or a storage apparatus such as a hard disk or an optical disc. Note that the storage unit 14 may also be configured to communicate with the control unit 15 via the communication control unit 13. In the present embodiment, the storage unit 14 stores, for example, a speaker diarization model 14a or the like used for speaker diarization processing to be described later.

The control unit 15 is implemented by using a CPU (Central Processing Unit), an NP (Network Processor), an FPGA (Field Programmable Gate Array), or the like and executes a processing program stored in a memory. Accordingly, as illustrated in FIG. 2, the control unit 15 functions as an acoustic feature extracting unit 15a, an array generating unit 15b, a speaker label generating unit 15c, a learning unit 15d, an estimating unit 15e, and an utterance section estimating unit 15f. It should be noted that these functional units may be respectively implemented in different hardware. For example, the learning unit 15d may be implemented as a learning apparatus and the estimating unit 15e may be implemented as an estimation apparatus. In addition, the control unit 15 may include other functional units.

The acoustic feature extracting unit 15a extracts an acoustic feature for each frame of an acoustic signal including an utterance by a speaker. For example, the acoustic feature extracting unit 15a receives input of an acoustic signal via the input unit 11 or via the communication control unit 13 from an apparatus or the like that acquires the acoustic signal. In addition, the acoustic feature extracting unit 15a divides an acoustic signal into frames, extracts an acoustic feature vector by performing discrete Fourier transform or filter bank multiplication on a signal from each frame, and outputs an acoustic feature sequence having been coupled in a frame direction. In this embodiment, a frame length is assumed to be 25 ms and a frame shift width is assumed to be 10 ms.

While the acoustic feature vector in this case is, for example, a 24-dimensional MFCC (Mel Frequency Cepstral Coefficient), the acoustic feature vector is not limited thereto and may be an another acoustic feature amount for each frame such as a mel filter bank output.

The array generating unit 15b divides a sequence of acoustic features for each frame of the acoustic signal into segments of a predetermined length and generates an array in which a plurality of divided segments in the row direction are arranged in the column direction. Specifically, the array generating unit 15b divides an input two-dimensional acoustic feature sequence into segments and converts the segments into a three-dimensional acoustic feature array as shown in FIG. 1. In other words, the array generating unit 15b divides the two-dimensional acoustic feature sequence of T-number of frames×D-number of dimensions into segments of L-number of frames by a shift width of N-number of frames. In addition, with each segment as each row, heads of the respective rows are connected so as to be aligned in the column direction to generate a three-dimensional acoustic feature array of (T−L)/N-number of rows×L-number of columns×D-number of dimensions. In the present embodiment, for example, L=500 and N=250.

The array generating unit 15b may be included in the learning unit 15d and the estimating unit 15e to be described later. For example, FIGS. 3 and 4 to be described later show an example in which the learning unit 15d and the estimating unit 15e perform processing of the array generating unit 15b.

The speaker label generating unit 15c uses an acoustic feature sequence to generate a speaker label of each frame. Specifically, as shown in FIG. 3, the speaker label generating unit 15c generates a speaker label for each frame using the acoustic feature sequence and a correct label of an utterance section of a speaker. Accordingly, a set of the acoustic feature sequence and the speaker label for each frame is generated as supervised data used for processing by the learning unit 15d to be described later.

When there are S-number of speakers (speaker 1, speaker 2, . . . , speaker S), a speaker label of a t-th frame (t=0, 1, . . . , T) is a S-dimensional vector. For example, when a frame of time point t×frame shift width is included in an utterance section of any speaker, a value of a dimension corresponding to the speaker is 1 and values of other dimensions are 0. Therefore, the speaker label for each frame is a T×S-dimensional binary [0, 1] multi-label.

Let us return to the description of FIG. 2. The learning unit 15d uses a generated array to generate, by learning, the speaker diarization model 14a for estimating a speaker label of a speaker vector of each frame. Specifically, the learning unit 15d trains the speaker diarization model 14a based on a bidirectional RNN by using a pair of an acoustic feature sequence and a speaker label for each frame as supervised data as shown in FIG. 3 and FIG. 4.

FIG. 4 illustrates a configuration of the speaker diarization model 14a based on a bidirectional RNN according to the present embodiment. As shown in FIG. 4, the speaker diarization model 14a is made up of a plurality of layers including a row-oriented RNN layer and a column-oriented RNN layer in addition to a segment division/arrangement layer being processing of the array generating unit 15b. In the row-oriented RNN layer and the column-oriented RNN layer, bidirectional processing in the row direction and the column direction of the input three-dimensional acoustic feature array is performed. In the present embodiment, a row-oriented BLSTM-RNN is applied as the row-oriented RNN layer and a column-oriented BLSTM-RNN is applied as the column-oriented RNN layer.

In addition, the speaker diarization model 14a has an overlap addition layer. As shown in FIG. 1, the overlap addition layer arranges each row of the three-dimensional acoustic feature array in the same manner as the acoustic feature sequence before the segment division and adds up the rows in an overlapping manner. Accordingly, a T×D-dimensional speaker label embedded sequence similar to the acoustic feature sequence is obtained.

Furthermore, the speaker diarization model 14a has a Linear layer for performing linear transformation and a sigmoid layer for applying a sigmoid function. As shown in FIG. 1, by inputting a T×D-dimensional speaker label embedded sequence to the Linear layer and the sigmoid layer, a speaker label posterior probability for each T×S-dimensional frame is output.

Using a posterior probability of a speaker label for each frame and multi-label binary cross entropy with the speaker label for each frame as a loss function, the learning unit 15d optimizes parameters of the linear layer, the row-oriented BLSTM-RNN layer, and the column-oriented BLSTM-RNN layer of the speaker diarization model 14a by backpropagation. The learning unit 15d uses an online optimization algorithm using a stochastic gradient descent method to optimize the parameters.

In this way, the learning unit 15d generates the speaker diarization model 14a including an RNN for processing the array in the row direction and an RNN for processing the array in the column direction. Accordingly, speaker diarization using local contextual information and speaker diarization using global contextual information can be performed. Therefore, the learning unit 15d can learn utterances of a same speaker separated in time as objects of speaker diarization.

Let us now return to the description of FIG. 2. The estimating unit 15e estimates a speaker label for each frame of an acoustic signal using the generated speaker diarization model 14a. Specifically, as shown in FIG. 3, by sequentially propagating an array generated by the array generating unit 15b from an acoustic feature sequence to the speaker diarization model 14a, the estimating unit 15e obtains speaker label posterior probability (an estimated value of a speaker label) for each frame of the acoustic feature sequence. The utterance section estimating unit 15f uses the output speaker label posterior probability to estimate an utterance section of a speaker in an acoustic signal. Specifically, the utterance section estimating unit 15f estimates a speaker label using a moving average of a plurality of frames. In other words, first, with respect to the speaker label posterior probability of each frame, the utterance section estimating unit 15f calculates a moving average in an 11-frame length including the frame, five frames preceding the frame, and five frames succeeding the frame. Accordingly, an erroneous detection of an unrealistically-short utterance section such as an utterance with only one frame can be prevented.

Next, when a value of the calculated moving average is larger than 0.5, the utterance section estimating unit 15f estimates that the frame is an utterance section of a speaker of the dimension. In addition, the utterance section estimating unit 15f regards a continuous utterance section frame group as one utterance for each speaker, and inversely calculates a start time and an end time of the utterance section up to a prescribed time point from the frame. Accordingly, an utterance start time point and an utterance end time point up to the prescribed time point for each utterance of each speaker can be obtained.

[Speaker Diarization Processing]

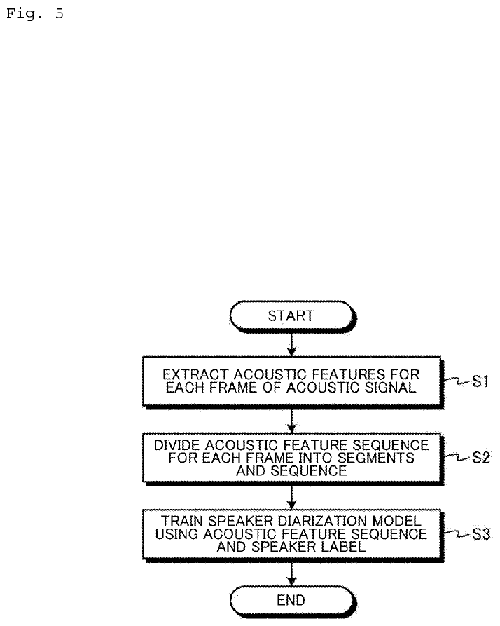

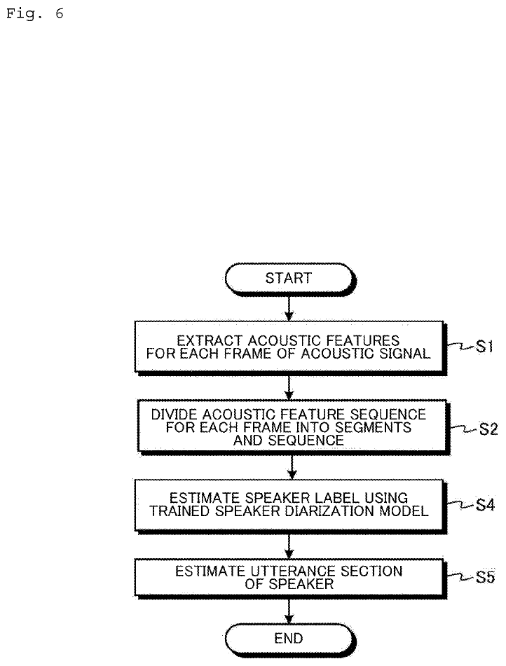

Next, speaker diarization processing by the speaker diarization apparatus 10 will be described. FIG. 5 and FIG. 6 are flowcharts showing speaker diarization processing procedures. The speaker diarization processing according to the present embodiment includes learning processing and estimation processing. First, FIG. 4 shows learning processing procedures. The flowchart in FIG. 5 is started at a timing when, for example, an instruction to start the learning processing is input.

First, the acoustic feature extracting unit 15a extracts an acoustic feature for each frame of an acoustic signal including an utterance of a speaker and outputs an acoustic feature sequence (step S1).

Next, the array generating unit 15b divides a two-dimensional acoustic feature sequence for each frame of the acoustic signal into segments of a predetermined length, and generates a three-dimensional acoustic feature array in which a plurality of divided segments in a row direction are arranged in a column direction (step S2).

In addition, using the generated acoustic feature array, the learning unit 15d generates, by learning, the speaker diarization model 14a for estimating a speaker label of a speaker vector of each frame (step S3). In doing so, the learning unit 15d generates the speaker diarization model 14a including an RNN for processing the array in the row direction and an RNN for processing the array in the column direction. Accordingly, a series of the learning processing is ended.

Next, FIG. 6 shows estimation processing procedures. The flowchart in FIG. 6 starts at a timing when, for example, an instruction to start the estimation processing is input.

First, the acoustic feature extracting unit 15a extracts an acoustic feature for each frame of an acoustic signal including an utterance of a speaker and outputs an acoustic feature sequence (step S1).

In addition, the array generating unit 15b divides a two-dimensional acoustic feature sequence for each frame of the acoustic signal into segments of a predetermined length, and generates a three-dimensional acoustic feature array in which a plurality of divided segments in a row direction are arranged in a column direction (step S2).

Next, using the generated speaker diarization model 14a, the estimating unit 15e estimates a speaker label for each frame of the acoustic signal (step S4). Specifically, the estimating unit 15e outputs speaker label posterior probability (an estimated value of a speaker label) for each frame of the acoustic feature sequence.

In addition, using the output speaker label posterior probability, the utterance section estimating unit 15f estimates an utterance section of a speaker in the acoustic signal (step S5). Accordingly, the series of estimation processing is ended.

As described above, in the speaker diarization apparatus 10 according to the present embodiment, the array generating unit 15b divides a sequence of acoustic features for each frame of an acoustic signal into segments of a predetermined length and generates an array in which a plurality of divided segments in the row direction are arranged in the column direction. In addition, using the generated array, the learning unit 15d generates, by learning, the speaker diarization model 14a for estimating a speaker label of a speaker vector of each frame.

Specifically, the learning unit 15d generates the speaker diarization model 14a including an RNN for processing the array in the row direction and an RNN for processing the array in the column direction. Accordingly, speaker diarization using local contextual information and speaker diarization using global contextual information can be performed. Therefore, the learning unit 15d can learn utterances of a same speaker separated in time as objects of speaker diarization. Accordingly, the speaker diarization apparatus 10 can perform speaker diarization with respect to a long acoustic signal with high accuracy.

In addition, using the generated speaker diarization model 14a, the estimating unit 15e estimates a speaker label for each frame of the acoustic signal. Accordingly, highly-accurate speaker diarization with respect to a long acoustic signal can be performed.

Furthermore, the utterance section estimating unit 15f estimates a speaker label using a moving average of a plurality of frames. Accordingly, an erroneous detection of an unrealistically-short utterance section can be prevented.

[Program]

It is also possible to create a program that describes, in a computer-executable language, the processing executed by the speaker diarization apparatus 10 according to the embodiment described above. In an embodiment, the speaker diarization apparatus 10 can be implemented by installing, in a desired computer, a speaker diarization program for executing the speaker diarization processing described above as packaged software or online software. For example, it is possible to cause an information processing apparatus to function as the speaker diarization apparatus 10 by causing the information processing apparatus to execute the speaker diarization program described above. Additionally, mobile communication terminals such as smartphones, mobile phones, and PHSs (Personal Handyphone Systems), slate terminals such as PDAs (Personal Digital Assistant), and the like are included in the scope of information processing apparatuses. Furthermore, functions of the speaker diarization apparatus 10 may be mounted to a cloud server.

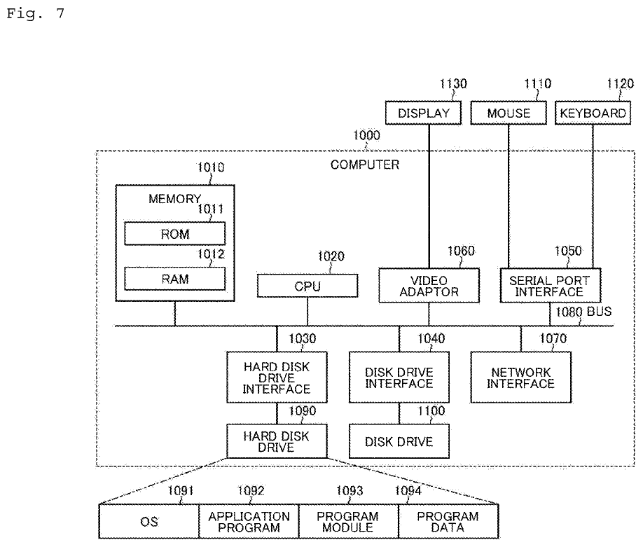

FIG. 7 is a diagram showing an example of a computer that executes the speaker diarization program. For example, a computer 1000 includes a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disc drive interface 1040 is connected to a disc drive 1041. A detachable storage medium such as a magnetic disk or an optical disc is inserted into the disc drive 1041. For example, a mouse 1051 and a keyboard 1052 are connected to the serial port interface 1050. For example, a display 1061 is connected to the video adapter 1060.

In this case, for example, the hard disk drive 1031 stores an OS 1091, an application program 1092, a program module 1093, and program data 1094. Each of the pieces of information described in the above embodiment is stored in, for example, the hard disk drive 1031 or the memory 1010.

In addition, for example, the speaker diarization program is stored in the hard disk drive 1031 as the program module 1093 in which commands to be executed by the computer 1000 are written. Specifically, the program module 1093 describing each type of processing executed by the speaker diarization apparatus 10 described in the above embodiment is stored in the hard disk drive 1031.

Furthermore, for example, data to be used in information processing in accordance with the speaker diarization program is stored as the program data 1094 in the hard disk drive 1031. In addition, the CPU 1020 reads out and loads the program module 1093 and the program data 1094 stored in the hard disk drive 1031 to the RAM 1012 when necessary to execute each of the above-described procedures.

Note that the program module 1093 and the program data 1094 pertaining to the speaker diarization program are not limited to being stored in the hard disk drive 1031 and, for example, may be stored in a removable storage medium and read out by the CPU 1020 via the disk drive 1041 or the like.

Alternatively, the program module 1093 and the program data 1094 pertaining to the speaker diarization program may be stored in another computer that is connected via a network such as a LAN (Local Area Network) or a WAN (Wide Area Network) to be read by the CPU 1020 via the network interface 1070.

Although an embodiment to which has been applied the invention made by the present inventor has been described above, the present invention is not limited by the description and the drawings that form a part of the disclosure of the present invention by way of the present embodiment. In other words, other embodiments, examples, operational techniques, and the like made by those skilled in the art or the like on the basis of the present embodiment are all included in the scope of the present invention.

### REFERENCE SIGNS LIST

10 Speaker diarization apparatus
11 Input unit
12 Output unit
13 Communication control unit
14 Storage unit
14a Speaker diarization model
15 Control unit
15a Acoustic feature extracting unit
15b Array generating unit
15c Speaker label generating unit
15d Learning unit
15e Estimating unit
15f Utterance section estimating unit

1. A speaker diarization method comprising:
dividing a sequence of acoustic features for each frame of an acoustic signal into segments of a predetermined length;
generating an array in which a plurality of divided segments in a row direction are arranged in a column direction; and
generating by learning, using the array, a model for estimating a speaker label of a speaker vector of each frame, wherein the speaker vector is associated with the array, and the model uses the speaker vector as input and estimates the speaker label as output.

2. The speaker diarization method according to claim 1, wherein the generating by learning further comprises generating the model wherein the model includes a recurring neural network for processing the array in the row direction and another recurring neural network for processing the array in the column direction.

3. The speaker diarization method according to claim 1,
further comprising:
estimating the speaker label for each frame of the acoustic signal using the generated model.

4. The speaker diarization method according to claim 3, wherein the estimating further comprises estimating the speaker label using a moving average of a plurality of frames of acoustic signals.

5. A speaker diarization apparatus comprising a processor configured to execute operations comprising:
dividing a sequence of acoustic features for each frame of an acoustic signal into segments of a predetermined length,
generating an array in which a plurality of divided segments in a row direction are arranged in a column direction; and
generating by learning, using the array, a model for estimating a speaker label of a speaker vector of each frame, wherein the speaker vector is associated with the array, and the model uses the speaker vector as input and estimates the speaker label as output.

6. A computer-readable non-transitory recording medium storing computer-executable speaker diarization program instructions that when executed by a processor cause a computer system to execute operations comprising:
dividing a sequence of acoustic features for each frame of an acoustic signal into segments of a predetermined length;
generating an array in which a plurality of divided segments in a row direction are arranged in a column direction; and
generating by learning, using the array, a model for estimating a speaker label of a speaker vector of each frame, wherein the speaker vector is associated with the array, and the model uses the speaker vector as input and estimates the speaker label as output.

7. The speaker diarization method according to claim 1, wherein the sequence of acoustic features for each frame of the acoustic signal is two-dimensional, and the array includes a three-dimensional acoustic feature array.

8. The speaker diarization method according to claim 1, wherein the dividing further comprises:
dividing the sequence of acoustic features as a two-dimensional acoustic feature sequence into a plurality of segments; and
converting the plurality of segments into a three-dimensional acoustic feature array as the array, each segment of the plurality of segments corresponding to a row, heads of the row being connected in alignment in the column direction.

9. The speaker diarization method according to claim 1, wherein the sequence of acoustic features is associated with a sequence of acoustic feature vectors, each acoustic feature vector is associated with a frame of the acoustic signal.

10. The speaker diarization apparatus according to claim 5, wherein the generating by learning further comprises:
generating the model, wherein the model includes a recurring neural network for processing the array in the row direction and another recurring neural network for processing the array in the column direction.

11. The speaker diarization apparatus according to claim 5, the processor further configured to execute operations comprising:
estimating the speaker label for each frame of the acoustic signal using the generated model.

12. The speaker diarization apparatus according to claim 11, wherein the estimating further comprises estimating the speaker label using a moving average of a plurality of frames of acoustic signals.

13. The speaker diarization apparatus according to claim 5, wherein the sequence of acoustic features for each frame of the acoustic signal is two-dimensional, and the array includes a three-dimensional acoustic feature array.

14. The speaker diarization apparatus according to claim 5, wherein the dividing further comprises:
dividing the sequence of acoustic features as a two-dimensional acoustic feature sequence into a plurality of segments; and
converting the plurality of segments into a three-dimensional acoustic feature array as the array, each segment of the plurality of segments corresponding to a row, heads of the row being connected in alignment in the column direction.

15. The speaker diarization apparatus according to claim 5, wherein the sequence of acoustic features is associated with a sequence of acoustic feature vectors, each acoustic feature vector is associated with a frame of the acoustic signal.

16. The computer-readable non-transitory recording medium according to claim 6, wherein the generating by learning further comprises:
generating the model, wherein the model includes a recurring neural network for processing the array in the row direction and another recurring neural network for processing the array in the column direction.

17. The computer-readable non-transitory recording medium according to claim 16, the computer-executable speaker diarization program instructions when executed further causing the computer system to execute operations comprising:
estimating the speaker label for each frame of the acoustic signal using the generated model.

18. The computer-readable non-transitory recording medium according to claim 6, wherein the sequence of acoustic features for each frame of the acoustic signal is two-dimensional, and the array includes a three-dimensional acoustic feature array.

19. The computer-readable non-transitory recording medium according to claim 6, wherein the dividing further comprises:
dividing the sequence of acoustic features as a two-dimensional acoustic feature sequence into a plurality of segments; and
converting the plurality of segments into a three-dimensional acoustic feature array as the array, each segment of the plurality of segments corresponding to a row, heads of the row being connected in alignment in the column direction.

20. The computer-readable non-transitory recording medium according to claim 6, wherein the sequence of acoustic features is associated with a sequence of acoustic feature vectors, each acoustic feature vector is associated with a frame of the acoustic signal.
